(19) United States
(12) Patent Application Publication
(10) Pub. No.: US 2005/0218741 A1
(43) Pub. Date: Oct. 6, 2005

(54) Generators, transformers and stators containing high-strength, laminated, carbon-fiber windings

(76) Inventors: Edward J. Wnorowski JR., Jacksonville, FL (US); Charles M. Darling IV, Houston, TX (US)

Correspondence Address: James Remenick;Intellectual Property Group, Powell Goldstein LLP, 901 New York Avenue, N.W., Third Floor, Washington, DC, 20001, US

(21) Appl. No.: 11/083,073

(22) Filed: Mar. 18, 2005

Related U.S. Application Data
(60) Provisional application No. 60/553,957, filed on Mar. 18, 2004.

(51) Int. Cl. H02K 3/00

(52) U.S. Cl. 310/179

(57) ABSTRACT

This invention is directed to motors, rotors and stators, transformers, generators and related apparatus comprising carbon fiber windings, and in particular, laminated carbon fiber windings for the generation of electrical energy. The invention is also directed to methods for generating electrical energy from devices of the invention and to methods for reconditioning and repairing conventional apparatus with carbon fiber windings.

### REFERENCE TO RELATED APPLICATIONS

This invention claims priority to U.S. Provisional Application No. 60/553,957 of the same title and filed Mar. 18, 2004, the entirety of which is hereby incorporated by reference.

### BACKGROUND

1. Field of the Invention

This invention is directed to motors, stators and rotors, transformers, generators, electrical connections and related apparatus comprising carbon fiber windings, and in particular, laminated carbon fiber windings for the generation of electrical energy. The invention is also directed to methods for generating electrical energy from devices of the invention and to methods for reconditioning and repairing conventional apparatus with carbon fiber windings.

2. Description of the Background

Electrical generators are used around the world for all applications that require energy and especially the generation of electrical energy. Accordingly generators can be found in many shapes and sizes for use in or as part of power tools, industrial machines, and power plants. Generator design and technology is disclosed generally in GE Rotor Design, Operational Issues, and Refurbishment Options by R. J. Zawoysky and K. C. Tornroos, GE Power Systems, GER-4212; GE Generator Technology Update by C. L. Vandervort and E. L. Kudlacik, GE Power Systems, GER-4203.

Most of the generators in use today are based on a common design. Basically a metal coil, typically copper, is wound around a core and a spinning force applied to the coil. Upon application of the mechanical force (i.e. the rotation), an excitation field current is applied generating an magneto-mechanical/electro-mechanical (MMF/EMF) field.

Generators have a limited life and must be repaired, reconstructed or replaced periodically. One component of a generator that is typically repaired or reconstructed, and can be upgraded or up-rated is the generator rotor which generates the MMF field. Degradation of the rotor can be caused by a number of factors, including a breakdown in insulation due to humidity, temperature and mechanical wear. This degradation can lead to shorted turns, a field ground, or an in-service operational incident that can require premature maintenance work. The type of work needed to repair and upgrade depends upon the generator rotor design, length of time in service and the manner in which the rotor was operated (see also GE Generator Fleet Experience and Available Refurbishment Options by A. Lemberg and K. Tornroos, GE Energy, GER-4223). Similar dynamics affect the stator of a generator creating a requirement for its repair or replacement.

Types of generators include generators that comprise conventionally-cooled windings (indirect copper cooling) and direct-cooled copper windings as well as those with spindle and body mounted retaining rings. Rewinding, modifying, upgrading or up-rating these windings are known for each field type. However, this process is both expensive and time consuming.

Thus, a need is present for generators and other electrical generating apparatus that have reduced wear, increased strength and resilience to temperature and mechanical wear over time, and require less insulation.

### SUMMARY OF THE INVENTION

The present invention overcomes the problems and disadvantages associated with current strategies and designs and provides new apparatus and methods for generating electrical energy.

One embodiment of the invention is directed to an apparatus for generating electrical energy that contains a rotor and a stator wherein either or both the rotor and the stator contain electrically conductive carbon-fiber windings that are capable of generating an electrical field; and a collector responsive to said electric field. Preferably the carbon fibers are codified solid and/or laminated carbon fibers, but need not be and may be in the nature of a doughnut with a carbonization surrounding a non-carbonized center. Also preferably, the carbon fibers windings comprise electrically conductive graphite, electrically-conductive carbon composites, codified solid fibers, laminated carbon fibers, PAN-based carbon fibers, pitch-based carbon fibers or combinations thereof. Carbon fibers of the invention may also be in the nature of a doughnut with a carbonization surrounding a non-carbonized center.

The carbon fiber windings provide the apparatus with increased resistance to high temperature, high humidity and/or mechanical force, as compared to conventional metal materials such as copper or aluminum. The apparatus may further comprise terminals for directing flow and electrical connections for transmitting electrical energy that both may contain electrically conductive carbon fibers of the invention, and one or more cooling fans or heat exchangers for reducing the temperature of said apparatus. Preferred apparatus of the invention include generators and large capacity generator for the production of electrical energy.

Another embodiment of the invention is directed to methods for generating electrical energy comprising generating electrical energy from the apparatus of the invention.

Another embodiment of the invention is directed to methods for refurbishing an apparatus for generating electrical energy comprising replacing existing windings of the apparatus with carbon fiber windings.

Another embodiment of the invention is directed to methods for refurbishing an electrical connection for transmitting electrical energy comprising replacing existing electrically conductive material of the electrical connection with carbon fiber windings. Preferred electrical connections are transmission lines for transmitting electrical energy.

Another embodiment of the invention is directed to stators comprising electrically conductive carbon-fibers that are capable of generating an electrical field. Preferred stators contain carbon fibers such as, but not limited to, electrically conductive graphite, electrically-conductive carbon composites, codified solid fibers, laminated carbon fibers, PAN-based carbon fibers, pitch-based carbon fibers and combinations thereof.

Another embodiment of the invention is directed to rotors comprising electrically conductive carbon-fiber windings that are capable of generating an electrical field. Preferred stators contain carbon fibers such as, but not limited to electrically conductive graphite, electrically-conductive carbon composites, codified solid fibers, laminated carbon fibers, PAN-based carbon fibers, pitch-based carbon fibers and combinations thereof.

Other embodiments and advantages of the invention are set forth in part in the description, which follows, and in part, may be obvious from this description, or may be learned from the practice of the invention.

### DESCRIPTION OF THE DRAWINGS

FIG. 1. Two phasor diagrams for synchronous generators of one embodiment of the invention.

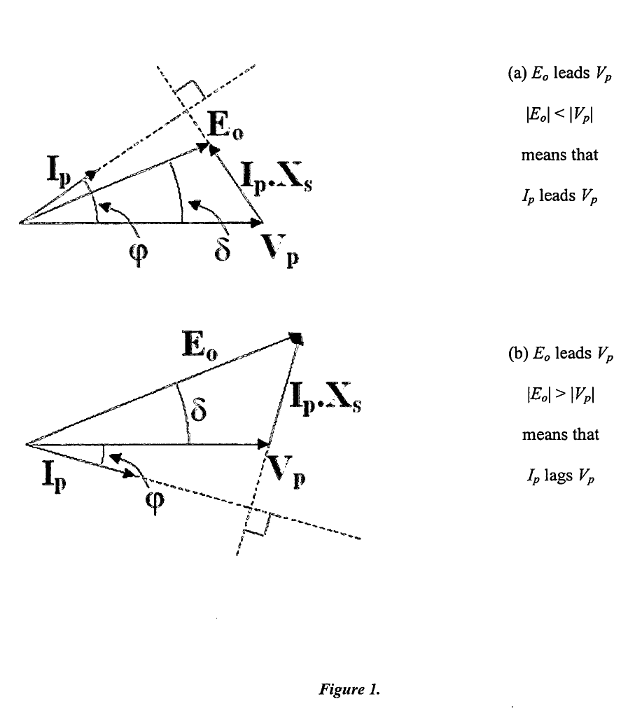

FIG. 2. Two watt meter embodiment of the invention.

FIG. 3. Specific strengths and moduli of carbon/carbon composites compared to those of metal matrix and other advanced composites

### DESCRIPTION OF THE INVENTION

As embodied and broadly described herein, the present invention is directed to carbon-fiber containing apparatus for generating electrical energy and to methods for manufacturing and repairing such apparatus.

Conventional generators and other similar apparatus for generating electrical energy utilize a combination of mechanical features that allow for the generation of electricity from mechanical motion. A generator is intended to include, any electrical apparatus that produces an electrical field, such as, but not limited to, transformers and any motors. The preferred generator is one which is used to generate vast amounts of electricity that is sent over transmission lines to consumers. A typical generator contains a rotor, a stator windings, cooling fans or another cooling mechanism such as one or more heat exchangers, collector rings, and terminals for directing the flow of electrical energy created. Such generators are subject to four significant forces that limit lifetime—the forces of temperature, humidity, mechanical force (e.g. friction), and insulative ability.

It has been surprisingly discovered that all three constraints of a generator design can be addressed by substituting existing copper and other winding material with another winding. Suitable materials for windings comprise electrically conductive carbon fibers, which includes, but is not limited to, electrically conductive carbon black, pitch-based carbon fiber, polyacrylonitrile (PAN)-based carbon fiber, synthetic graphite, carbon-based composites such as carbon/carbon and carbon/metal composites, and combinations and mixtures thereof. Many of these types of carbon fibers are widely commercially available.

Although the term “Carbon fibers” is generally understood to apply to fibers having a carbon content of greater than 92% by weight, while the term “Graphite fibers” is generally known to apply to fibers having a carbon content of greater than 98% by weight, it is intended herein that the term “carbon fibers” should apply to fibers having a carbon content of greater than 50% by weight. Accordingly, the term “carbon fibers” as used herein is intended to be inclusive of “carbon” and “graphitic fibers”. Preferably, carbon fibers of the invention have a carbon content of about 50%-98% by weight, more preferably of about 75%-98% by weight, and even more preferably of about 95%-98% by weight. Composite carbon fibers of the invention, depending of the specific components thereof, preferably have a carbon content of about 50%-90% by weight, more preferably of about 60%-85% by weight, and even more preferably of about 70%-80% by weight.

Conductive carbon fibers function in a similar manner to copper and other metals, while providing an increased strength, an increased electrical generation, reduced weight and longer life to the apparatus. Many are of similar sizes and are or can easily be similarly shaped as well. Preferred carbon fibers that can be used in the invention include, but are not limited to, those disclosed in U.S. Pat. Nos. 5,518,836; 5,532,083; 5,700,573; 5,763,103; 5,776,607; 5,776,609; 5,821,012; 5,837,626 and 5,858,530, the disclosures of which are all entirely incorporated by reference.

Also preferred are carbon fibers derived from polyacrylonitrile (PAN) as precursor such as SIGRAFIL C® (SGL Carbon Group). SIGAFIL® is a heavy tow carbon fiber that combines high strength, high modulus of elasticity and low density. SIGRAFIL C is a strong materials with high electrical conductivity. Also preferred are carbon fibers containing Pyrograf® (Applied Sciences, Inc.), which is a very fine, highly graphitic, low cost, carbon nanofiber. Pyrograf® provides enhanced electrical conductivity over a broad range and mechanical reinforcement of matrix materials. Other benefits include improved heat distortion temperatures and increased electromagnetic shielding. Another preferred carbon fiber is CARBONCONX™ (Xerox), which comprises thousands of carbon fibers bundled by low-pressure pultrusion. This process involves pulling the carbon fibers and a thermoplastic or thermosetting polymer through a shaping/curing die. The result is a high-strength, electrically conductive material. In addition, electrical conductivity of these fibers can be precisely tuned if desired. Other carbon fibers include Delrin 300AS™ and 300A™ (DuPont), which both utilize carbon fiber to provide ESD capability (e.g. 106 ohm/sq).

Carbon fibers containing or composed of composites may also be utilized in embodiments of the invention due of their high strength-to-weight ratio and significant weight reduction as compared to metals and alloys (see “High Thermal Conductivity composites for passive thermal management,” Metal Matrix Composites Information Analysis Center—Current Highlights, 8(2) 1988). High temperature applications are possible from proper placement of correct reinforcing fibers. For example, pitch-based reinforcing fibers, oriented in the direction of the thermal gradient, while maintaining the overall conductivity, reduces temperatures, thus providing improved performance, reliability and stability of polymeric composites. For even higher temperature applications, carbon/carbon composites can be used. Many forms of such composites can have a near zero thermal expansion. This near zero thermal expansion makes them useful to rapidly dissipate heat. While pitch-based fibers are often employed because of their high thermal conductivity, their high modulus can offer additional benefits such as reduced temperature and enhanced shape stability.

Currently, high thermal conductivity fibers are used as a reinforcement for metal matrix composites. The resulting less dense material has a thermal higher conductivity than that of the metal matrix. For example, a carbon fiber/copper composite with a 39% volume fraction of fibers has a density of 6.24 g/cc, as compared to 8.96 g/cc for pure copper. Density of typical carbon/carbon composites is considerably lower at approximately 1.5-1.9 g/cc. Thus, from the viewpoint of weight reduction, the use of carbon/carbon is preferred.

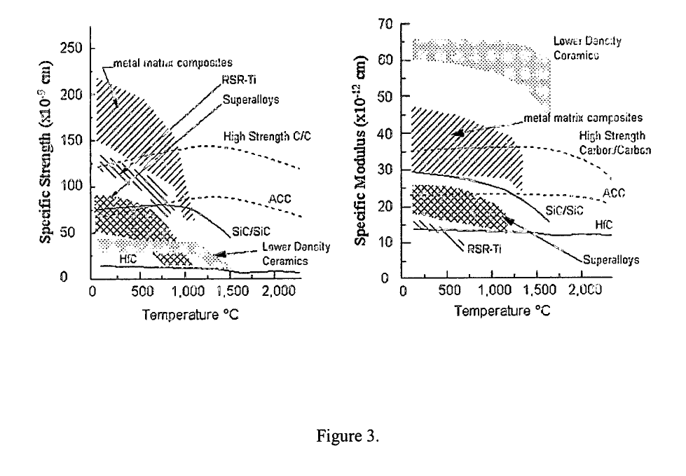

Thermal conductivity of a composite often depends more on the matrix structure than on the types of fibers themselves. One reason is that often some of the fibers are broken and are, thus, discontinuous down the length of the composite thereby reducing thermal transport. Although it is preferred that carbon fibers of the invention have few discontinuous fibers, for applications of the invention involving a high thermal conductivity matrix such as graphitic carbon, both fibers and matrix contribute to high thermal conductivity. Because thermal conductivity of graphite is higher than that of a metal, carbon/carbon is ideal for high thermal conductivity composites. Furthermore, at temperatures exceeding 1,100° F. (593° C.), carbon/carbon composites exhibit higher strengths and moduli than metal matrix composites (FIG. 3). Overall, the combination of higher strength, lower density (and weight), and higher thermal conductivity makes carbon/carbon as well as metal matrix composites preferred in many embodiments of the invention.

It is also preferred that carbon fibers have few or no detectable discontinuous fibers, which means that broken fibers could not be detected within the limits of the detection technology employed. Fibers are preferably of full-length and manufactured in such as way as to provide continuous electrical conduction along their length. Conduction may be two-way (i.e. bidirectional) or one-way (i.e. unidirectional), as desired.

Accordingly, one embodiment of the invention is directed to the windings of stators and rotors (e.g. the coils), including the windings of generators, transformers, motors and other similar apparatus. Preferably windings are comprised of high-strength, continuously wound carbon-fibers. Fibers may be soft or hardened such as with a resin (e.g. graphite resins). The benefits of the invention include, but are not limited to, significantly increasing generator power factor lag; decreasing prime mover fuel consumption; increasing generator output; increasing generator life at least by reducing load on generator parts; and allowing for increased cycling of the generator. Similar benefits are achieved with rotors, stators, transformers and motors of the invention. In addition, insulation of the windings with non-conductive carbon fibers increases insulation viability, increases winding permeability above what could be achieved for equivalent output, increases reluctance, flux density, and insulation properties, increases generator life and increases, resultantly generator, stator, transformer and motor performance and output.

Another embodiment of the invention is directed to carbon fibers for the transmission of electrical energy. Electrical connections such as, but not limited to, transmission lines, cables and wires, are composed of electrically conductive material, typically copper, aluminum, silver or other alloys or metals, surrounded by insulating material. These electrical connections can be manufactured or refurbished, or completely reconditioned with carbon fibers of the invention. With refurbishment and reconditioning, some or all of the electrically conductive material is removed and replaced with carbon fiber of the invention. When all conductive material has been substituted with carbon fibers, the process may be referred to as complete or as complete replacement. Thus, another embodiment of the invention is directed to methods for repairing conventional apparatus for generating electrical energy by replacing worn or broken cooper windings with carbon fiber windings of the invention. It is also envisioned that there are situations where only some of the conductive material may be replaced with carbon fibers of the invention. An important aspect of the invention is refurbishment and/or replacement of transmission cables in the area of a generator. In power generation facilities, for example, the entirety of the cables and wires of the facility may be refurbished or replaced with carbon fibers wiring of the invention for increased resistance to heat, cold, humidity, friction, and overall wear. Further, such wiring provides increased strength and insulative capability as compared to copper and other metal wiring, thus, reducing maintenance time and costs.

Preferably windings are made from conductive carbon fibers that are woven together including those that are pliable woven cloth of four to eight ply. Woven fibers can be codified solid, doughnut and/or laminated and stacked to from pliable laminations of a desired thickness. The preferred rage includes from 0.001 (0.00254 cm) to one inch (2.54 cm) in thickness, and more preferred is 0.125 (0.3175 cm) to 0.5 inches (1.27 cm) in thickness. The carbon fibers can be any form of conductive carbon fiber, and bipolar (i.e. conductive in opposite directions) or monopolar (i.e. conductive in one direction), or a combination thereof. There are two types of generally available carbon fibers: Polyacrylonitrile (“PAN”) based carbon fiber; and pitch-based carbon fiber. PAN is a commercially available acrylic textile fiber and is a ready-made starting material for carbon fiber to be utilized in the invention. Pitch is used as a starting material for pitch-based carbon fibers and is readily available as a by-product of the refining process. Pitch is also a ready-made starting material for carbon fiber to be utilized in the invention. Additional forms and structures of carbon fibers can be selected or even empirically developed by one skilled in the art utilizing other bases for the starting material that once treated, develop conductive properties for use as windings or so as to maintain insulating properties suitable for use as the insulating medium. However, the insulating medium may comprise non-conductive carbon fiber or other well-known and commercially available non-conductive materials.

In a manufacturing process of the invention, fibers are stabilized by thermosetting (crosslinking) so that the fibers do not melt in subsequent processing steps. However, the stabilization process utilized is not particularized, with the main requirement of the stabilization process being to allow subsequent exposure to those temperature levels that are required to create conductive properties in the carbon fiber. In addition, PAN fibers are generally stretched as well, although this is not a required step.

To create conductive carbon fibers, selected fibers are carbonized by pyrolization until the fibers are transformed into carbon fiber of desired characteristics. Heating PAN fibers to 1,800° F. (982° C.) yields carbon fibers of 94% carbon and 6% nitrogen. Increasing the heat application to 2,300° F. (1,260° C.) yields a fiber of 99.7% carbon. The higher the carbon level in these particular processes, the more efficient is the conductivity of the fiber. Similar heat applications can be made with pitch-based fibers to achieve the desired level of conductive properties. For developing other carbon fibers, the heat application can be as sufficient to create the desired conductivity in the carbon fiber. These steps are avoided for carbon fibers to be utilized as insulation for carbon fiber to be utilized as insulating material.

To optimize conductive characteristics, the carbon fiber is graphitized by exposing the fibers to temperatures greater than 3,200° F. (1,760° C.). This improves tensile modulus by improving crystalline structure and three-dimensional nature of the structure. The fibers can be surface treated; sizing agent is applied; finish is applied; and a coupling agent is applied. The conductive fibers are then either grouped and bound by winding or woven into blankets or otherwise assembled into a medium appropriate for development into the winding laminations to be utilized as the coils, replacing the copper and/or aluminum utilized in the stator and rotor of the present-day generator. In addition, non-conductive fibers can be woven into blankets or tapes to be used as insulation. However, the use of the carbon-fiber insulation, although a further enhancement to the use of the conductive-carbon fiber as a winding is not fundamental to the invention reflected herein.

Because of the nature of the carbon fiber, the amount of the conductive material that can be included in the existing winding space of the rotor/field winding, stator winding, transformer winding and motor field/stator is increased, with reduced weight, allowing the increase in output and the reduction in the motive power required to power the subject items. For example, because of the strength of the carbon fiber, the carbon fiber configuration will allow more turns per coil, allow an increase in the turn ratio, and thereby increase the MMF power factor. In addition, because of the reduced resistance in the carbon fiber, the lag is increased, allowing more efficient power production. The use of non-conductive carbon fiber as insulator material on the windings allows for more space to be utilized by the conductive material and less space to be utilized by the insulating material, thereby further increasing the area of the conductive material, although use of a carbon fiber insulator material is not required. At the same time, the reduced weight reduces the forces on the generator field forging and the stator, the rotor and the end turns. Rotor bearing friction losses are also reduced, thereby increasing service life and allowing more frequent cycling of the units without an attendant increase in maintenance requirements. Similar advantages can be achieved for transformers and motors.

The conductive carbon fiber medium is then connected to through mechanical connection to the collector ring or the diode ring, stator high voltage bushings, transformer taps and motor connections.

This design can be incorporated into new generator, stator, transformer and motor installations, and such installations as so constructed.

After winding a generator field with the conductive carbon fiber, the following experiments are performed: Similar experiments can be understood and designed by one of ordinary skill from the disclosures herein for rotors, stators, transformers and motors.

The following examples illustrate embodiments of the invention, but should not be viewed as limiting the scope of the invention.

### EXAMPLES

### Example A

### Investigation into the Variation of Power Factor Versus Excitation

To investigate the effects of varying the excitation field on the power factor of the generator current at various mechanical loads.

A synchronous generator is loaded by applying mechanical torque to the shaft that causes the induced e.m.f. to lead the terminal voltage. The difference between Eₒ and Vₚ is dropped across the synchronous reactance and causes a phase current to flow. Notice that the resultant current may not only change in magnitude but can also change phase, thus influencing the power factor. Not only can the phase of the e.m.f. be controlled, but the magnitude of the e.m.f. may also be adjusted. Excitation Voltage and Current.

From the phasor diagrams it can be seen that the power factor of the synchronous generator may be varied by increasing or decreasing the excitation. To draw the phasor diagram the following procedure may be used:
1. A line proportional to the phase terminal voltage is drawn along the horizontal.
2. The direction of the load current is drawn at the correct load power factor angle φ.
3. A phasor, proportional to the reaction voltage I_{P}X_{S}, is then added in the direction 90 degrees leading to the current.
4. Finally, the open circuit voltage E_{O} and the load angle δ are found.
5. The total input W_{shaft} (shaft power) can be found from the phasor diagram and is given by:

$${W}_{shaft} = 3 \times \frac{{V}_{p} {E}_{0}}{{X}_{s}} sin δ \qquad ( 6 )$$

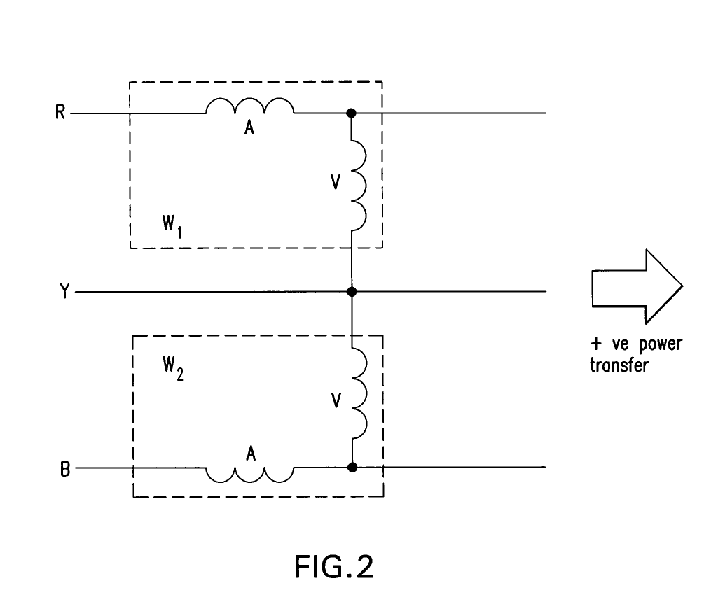

To measure power the “two wattmeter” method is used which also allows the determination of power factor, as is described herein.
The wattmeter voltage coils are connected across the supply lines, and the current coils are connected in the supply lines as shown in FIG. 2. The total power delivered by the three phase supply is equal to the sum (which includes any negative values) of the two wattmeter readings, W₁ and W₂. Thus:
W₁+W₂=3Wₚ (3)
where Wₚ is the phase power. Also:
   W₁+W₂=3VₚIₚ cos φ=\sqrt{3V_{L}I_{L}}cos φ (4)
   where cos φ is the load power factor, and φ is the power factor angle.
   Note: it is possible for one of the wattmeter readings to be negative and the reverse switch on the wattmeter should be used to record this negative reading.

From eqn. (4) the load power factor is found from the line readings using either

$$\begin{matrix}cos φ = \frac{{W}_{1} + {W}_{2}}{\sqrt{3 {V}_{z} {I}_{z}}} or & ( 5 ) \\ φ - {tan}^{- 1} [ \sqrt{3} \frac{{W}_{2} - {W}_{2}}{{W}_{1} + {W}_{2}} ] & ( 6 )\end{matrix}$$

Note: the convention is that positive φ indicates a lagging current.

In practice the above formulae will each give different values of power factor because of the cumulative effect of the errors in the voltage, current, and wattmeters. The direct formula, eqn. (5), should be used in most cases. However, the tan formula, eqn. (6), is generally more accurate at close to unity power factors, i.e. cosφ>0.9, when the power factor angle is small.

One may use the synchronous machine circuit diagram in combination with the two wattmeter method for measuring 3-phase power. First, a complete circuit diagram is drawn before connecting the circuit. A plan is made as to how one is to take the measurements and over what range of values—also assessing the permissible range of other quantities.

Associate results with theory, taking into account previous experiments such as the open-circuit characteristic, the measurement of Xₛ or the T vs δ characteristic. Consider practical applications of results especially for power factor correction.

### Example B

### Investigation into the Torque/Load Angle Characteristic with Excitation and Hence Stability

To investigate the effects of excitation on the torque versus load angle characteristic and to determine the limit of stability.

The equation for the total input (shaft) power for a synchronous machine is given by:

$${W}_{shaft} = 3 \frac{{V}_{p} {E}_{o}}{{X}_{s}} sin δ \qquad ( 1 )$$

To find information on the torque versus load angle characteristic for synchronous machines one needs to ascertain how this is influenced by the magnitude of the excitation field. One can also determine what is meant by “stability”, why it is important, and the difference between “static” and “transient” stability. Further, one can determine how to connect the circuit and assess the permissible ranges of all of the quantities to measure.

Results are linked back to the theory and previous experiments. Types of stability are determined during this test and how the test is influenced by disturbances. Generators on-load can be disconnected due to faults and automatic voltage control, and both implicate stability.

Other embodiments and uses of the invention will be apparent to those skilled in the art from consideration of the specification and practice of the invention disclosed herein. All references cited herein, including all publications, U.S. and foreign inventions and invention applications, are specifically and entirely incorporated by reference. It is intended that the specification and examples be considered exemplary only.

1. An apparatus for generating electrical energy that contains:
a rotor and a stator wherein either or both the rotor and the stator contain electrically conductive carbon-fiber windings that are capable of generating an electrical field; and a collector responsive to said electric field.

2. The apparatus of claim 1, wherein the carbon fibers windings comprise electrically conductive graphite.

3. The apparatus of claim 1, wherein the carbon fibers windings comprise electrically-conductive carbon composites.

4. The apparatus of claim 1, wherein the carbon fibers windings are selected from the group consisting of codified solid fibers, laminated carbon fibers, PAN-based carbon fibers, pitch-based carbon fibers and combinations thereof.

5. The apparatus of claim 1, wherein the carbon fiber windings provide the apparatus with increased resistance to high temperature, high humidity and mechanical force, as compared to copper windings.

6. The apparatus of claim 1, further comprising terminals for directing flow of electrical energy.

7. The apparatus of claim 6, wherein the terminals contain electrically conductive carbon fibers.

8. The apparatus of claim 1, further comprising electrical connections that transmit electrical energy generated by the apparatus.

9. The apparatus of claim 8, wherein the electrical connection are transmission lines that contain electrically conductive carbon fibers.

10. The apparatus of claim 1, further comprising one or more cooling fans or heat exchangers for reducing the temperature of said apparatus.

11. The apparatus of claim 1 which is a generator.

12. The apparatus of claim 11, which is a large capacity generator for the production of electrical energy.

13. A method for generating electrical energy comprising generating electrical energy from the apparatus of claim 1.

14. A method for refurbishing an apparatus for generating electrical energy comprising:
replacing existing windings of the apparatus with carbon fiber windings.

15. A method for refurbishing an electrical connection for transmitting electrical energy comprising:
replacing existing electrically conductive material of the electrical connection with carbon fiber windings.

16. The method of claim 15, wherein the electrical connection is a transmission line for transmitting electrical energy.

17. A stator comprised of electrically conductive carbon-fibers that are capable of generating an electrical field.

18. The stator of claim 17, wherein the carbon fibers are selected from the group consisting of electrically conductive graphite, electrically-conductive carbon composites, codified solid fibers, laminated carbon fibers, PAN-based carbon fibers, pitch-based carbon fibers and combinations thereof.

19. A rotor comprised of electrically conductive carbon-fiber windings that are capable of generating an electrical field.

20. The rotor of claim 19, wherein the carbon fibers are selected from the group consisting of electrically conductive graphite, electrically-conductive carbon composites, codified solid fibers, laminated carbon fibers, PAN-based carbon fibers, pitch-based carbon fibers and combinations thereof.
